(19) United States
(12) Patent Application Publication
(10) Pub. No.: US 2019/0364745 A1
(43) Pub. Date: Dec. 5, 2019

(54) CONTAINER FOR POTTING PRE-PLANTED OBJECTS

(71) Applicant: Scott Soutullo, Mobile, AL (US)

(72) Inventor: Scott Soutullo, Mobile, AL (US)

(21) Appl. No.: 16/424,782

(22) Filed: May 29, 2019

Related U.S. Application Data
(60) Provisional application No. 62/679,769, filed on Jun. 2, 2018.

(51) Int. Cl. A01G 9/02

(52) U.S. Cl. CPC A01G 9/02; A01G 2009/003

(57) ABSTRACT

A container for potting pre-planted objects is provided. The container provides a manipulable container adapted to receive objects by way of either vertical or horizontal insertion or deposit into the container's interior volume. The container may include a container body having an open top end, an open bottom end, and a break extending from the top end to the bottom end. The container may include a fastener transitionable between a disengaged configuration and an engaged configuration to transition the container between an open configuration and closed configuration. The width of the break may be adjusted when the fastener is in a disengaged configuration to permit horizontal insertion or deposit of objects through the break and into the container's interior volume.

### CROSS-REFERENCE TO RELATED APPLICATIONS

This application claims priority to U.S. Provisional Patent Application Ser. No. 62/679,769, entitled “MANIPULABLE CONTAINER”, filed on Jun. 2, 2018, the entirety of which is incorporated herein by reference.

### FIELD OF THE DISCLOSURE

The subject matter of the present disclosure relates generally to a container for potting pre-planted objects.

### BACKGROUND

The traditional gardening and landscaping containers often utilized for various gardening and landscaping applications are generally only capable of receiving particulate matter or plant life therein by way of vertical insertion or deposit of such particulate matter or plant life into the containers' interior volumes. That is, objects may be introduced into the interior volume of such traditional containers only by depositing an object into the top, or in some instances bottom, portion of the container.

Traditional gardening and landscaping containers, such as ceramic flower pots or plastic nursery pots, are generally configured to receive particulate matter or plant life into their interior volumes primarily through an opening disposed at the top of the containers that is defined by the containers' sidewalls. The sidewalls of such containers generally extend upwardly from the containers' bases and are of continuous, ceaseless construction in order to prevent the particulate matter or plant life disposed within the containers' interior volumes from escaping. The continuous, ceaseless sidewall construction establishes a vertical barrier between the interior volume of the container and the external environment. As such, traditional gardening and landscaping containers are generally incapable of receiving particulate matter or plant life therein via horizontal insertion or deposit, i.e., objects cannot be horizontally introduced into the interior volume of traditional containers through the containers' sidewalls. In some instances, the base of such containers may include one or more openings to facilitate liquid drainage from the containers' interior volume. However, because the diameter of the openings within the base need only be wide enough to permit a stream of liquid to flow therethrough sufficient to allow drainage from the containers' interior volumes, the openings within the containers' bases are generally substantially smaller than the diameter of the opening disposed at the top of the containers and defined by the containers' sidewalls. Accordingly, the diameter of the opening disposed at the top of traditional gardening and landscaping containers generally defines the outermost diametric limits as to what objects can be inserted, to any extent, within the containers' interior volume.

The inability to horizontally receive objects into the interior volume due to the continuous, ceaseless sidewall construction and the diameter restrictions imposed by the top opening of traditional gardening and landscaping containers significantly limits the type of objects that can be utilized with or potted within such containers. As such, the general construction of traditional gardening and landscaping containers often renders them ineffective for many gardening and landscaping applications. For instance, traditional landscape and gardening containers generally cannot be utilized to pot pre-planted trees or shrubbery because pre-planted plant life generally cannot be vertically introduced into the interior volume of traditional gardening and landscaping containers once planted. Additionally, traditional landscape and gardening containers cannot be utilized to pot trees or shrubs having a foliage and root assembly of greater diameter than that of a container's opening, regardless of whether the root assembly is planted within the ground.

New apparatuses, systems, and methods that serve to cure the limitations and deficiencies consistent with traditional gardening and landscaping containers are described herein.

### SUMMARY

A container for potting pre-planted objects is provided. The container of the present disclosure is generally designed to provide a manipulable container which can be used to pot pre-planted objects and/or objects having oversized ends rendering such objects incapable of being potted in traditional landscape and gardening containers. To this end, the container of the present disclosure is adapted to receive particulate matter and/or plant life therein by way of either vertical or horizontal insertion into its interior volume. In an embodiment, the container includes a container body defining an interior volume that may be occupied by particulate matter, plant life, or other desired objects and a fastener transitionable between a disengaged configuration an engaged configuration to transition the container between an open and closed configuration.

In an embodiment, the container body may have an open top end and an open bottom end to permit vertical insertion of smaller objects into the interior volume and/or to permit objects having a height greater than that of the container body to extend entirely through the interior volume once potted. To permit horizontal insertion of objects into the interior volume, the container body includes a break extending from the container body's top end to its bottom end such the interior and exterior surfaces of the container body is non-continuous. When the container is in an open configuration, the width of the break may be adjusted to assume a first width to permit passage of particulate matter, plant life, or other desired objects having a diameter or width less than the first width through the break and into the interior volume. When the container is in a closed configuration, the break exhibits a second width smaller than the first width. In an embodiment, the second width may be sufficiently small such that objects introduced into the interior volume cannot subsequently exit through the break.

In some embodiments, the fastener may comprise a first interlocking member and a second interlocking member, where the fastener retains an engaged configuration when the first and second interlocking members are interlocked and a disengaged configuration when the first and second interlocking members are not interlocked. In an embodiment, at least one of the first interlocking member and the second interlocking member may be disposed within the interior volume when the fastener is an engaged configuration. In an embodiment, the fastener may be defined, at least in part, by one or more portions of the container body. In other embodiments, the fastener may be defined, at least in part, by one or more components secured a surface of the container body.

In some embodiments, the container may include a container body having a first break and a second break each extending from the container body's top end to its bottom end and a first and second fastener each transitionable between a disengaged and engaged configuration. In one embodiment, the container body may be defined by a first body member and a second body member, where the first body member and the second body member are removably secured when at least one of the first fastener and the second fastener are placed in an engaged configuration.

Because the container of the present disclosure is adapted to receive objects by way of horizontal insertion, the container of the present disclosure may be used to pot plant life whose roots have already been sown into a ground surface. For instance, the container of the present disclosure may be used to pot a planted tree by placing the container in an open configuration, passing the trunk of the tree through the break within the container body so that the trunk is disposed within the container's interior volume and extends longitudinally through the container body, and placing the container body in a closed configuration by engaging the fastener. The foregoing steps may be similarly carried out to pot other plant life or objects having opposing ends exhibiting a first diameter greater than the diameter of the container and a midsection exhibiting a second diameter smaller than that of the diameter of the container's top and bottom openings.

The foregoing summary has outlined some features of the apparatus and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purposes of the apparatus, system, and methods disclosed herein. Those in the pertinent art should also realize that such equivalent designs or modifications do not depart from the scope of the apparatus, system, and methods of the present disclosure.

### DESCRIPTION OF THE DRAWINGS

These and other features, aspects, and advantages of the present disclosure will become better understood with regard to the following description, appended claims, and accompanying drawings where:

FIG. 1 is a front perspective view of a container in a closed configuration and having features consistent with an embodiment of the present disclosure being used to pot pre-planted plant life and particulate matter;

FIG. 2 is a front perspective view of a container in an open configuration and having features consistent with an embodiment of the present disclosure;

FIG. 3 is a top perspective view of a container in a closed configuration and having features consistent with an embodiment of the present disclosure;

FIG. 4 is a side perspective view of a container in a closed configuration and having features consistent with an embodiment of the present disclosure;

FIG. 5 is a top view of a container in a closed configuration and having features consistent with an embodiment of the present disclosure being used to pot plant life and particulate matter;

FIG. 6 is a top view of a container in a closed configuration and having features consistent with an embodiment of the present disclosure;

FIG. 7 is a top view of a container in a closed configuration and having features consistent with an embodiment of the present disclosure;

FIG. 8 is a top perspective view of a portion of a container in an open configuration and having features consistent with an embodiment of the present disclosure;

FIG. 9 is a top perspective view of a container in a closed configuration and having features consistent with an embodiment of the present disclosure;

FIG. 10 is top perspective view of a container transitioning from a closed to open configuration and having features consistent with an embodiment of the present disclosure; and

FIG. 11 is an exploded view of a container in an open configuration and having features consistent with an embodiment of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, “includes”, and grammatical equivalents thereof are open-ended and are used herein to mean that other components, steps, etc. are optionally present. For example, a system “comprising” components A, B, and C can contain only components A, B, and C, or can contain not only components A, B, and C, but also one or more other components. The term “removably secured” and grammatical equivalents thereof are used herein to mean the joining of two components in a manner such that the two components are secured together, but may be detached from one another and re-secured together without requiring the use of specialized tools.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). Throughout the present disclosure, reference may sometimes be made to an object being “vertically inserted” or “vertically deposited” into an interior volume defined by a container body 11 or to an object being introduced into an interior volume defined by a container body 11 by way of “vertical insertion” or “vertical deposit”. When such reference is made, it is understood that the present disclosure is referring to instances, or potential instances, where an object is or may be introduced into the interior volume by passing through a top opening 16A or bottom opening 12C within the container's 10 container body 11. Additionally, reference may sometimes be made to an object being “horizontally inserted” or “horizontally deposited” into an interior volume defined by a container body 11 or to an object being introduced into an interior volume defined by a container body 11 by way of “horizontal insertion” or “horizontal deposit”. When such reference is made, it is understood that the present disclosure is referring to instances, or potential instances, where an object is or may be introduced into the interior volume by horizontally passing through a break 20, 20A, 20B within the container's 10 container body 11.

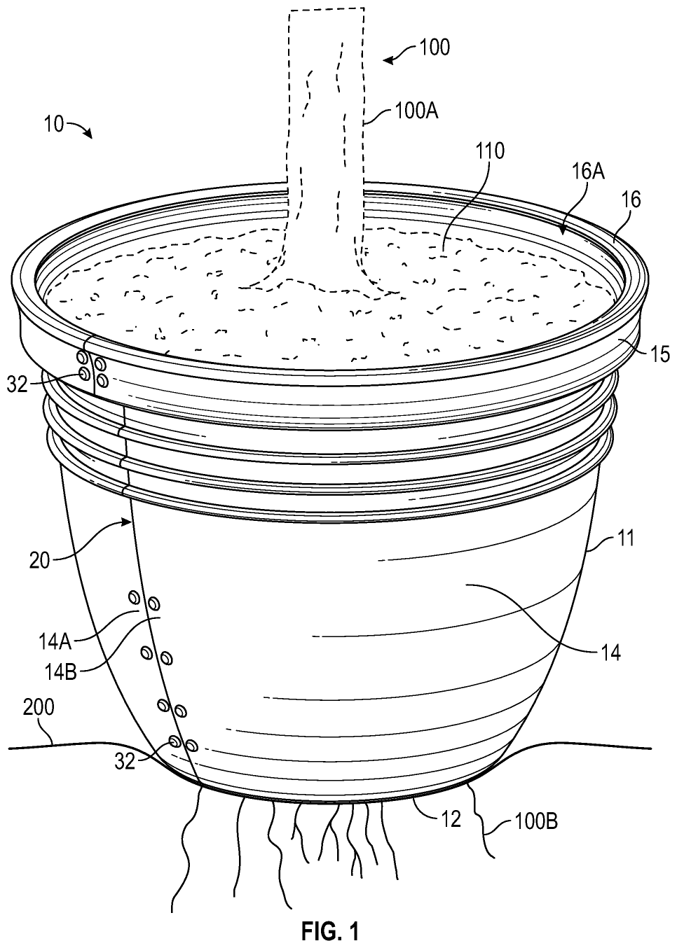

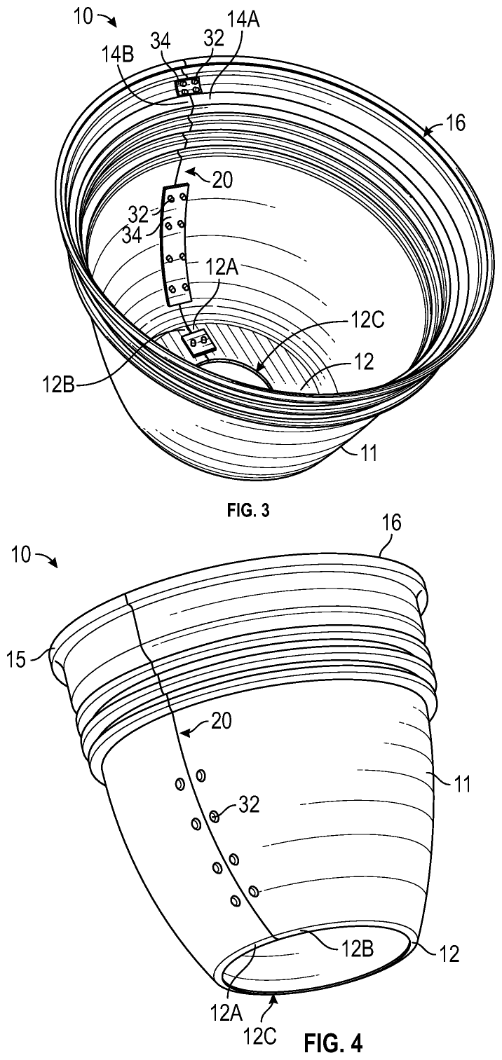

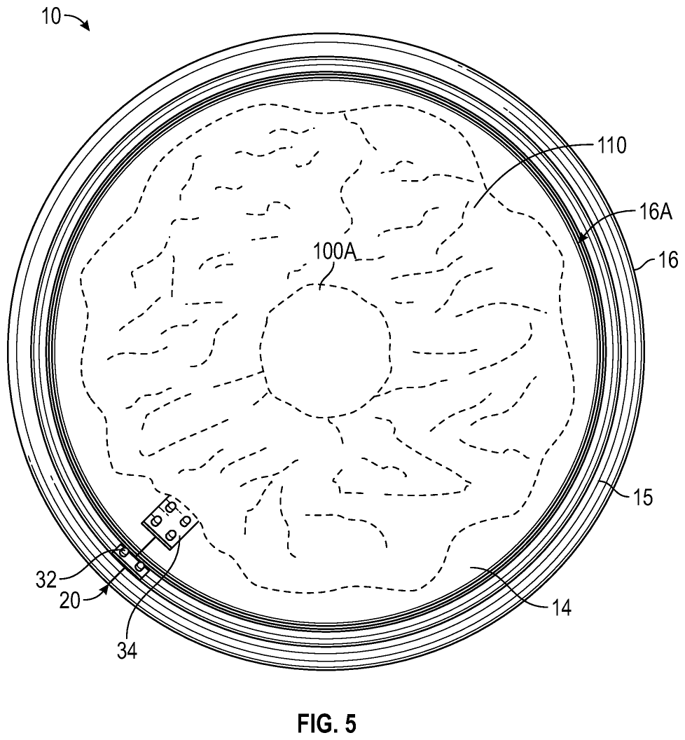

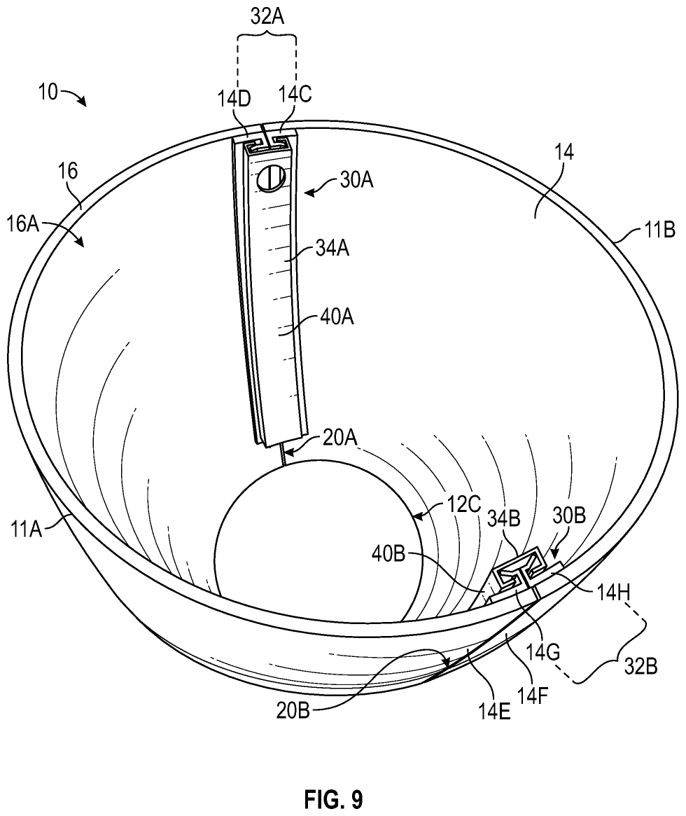

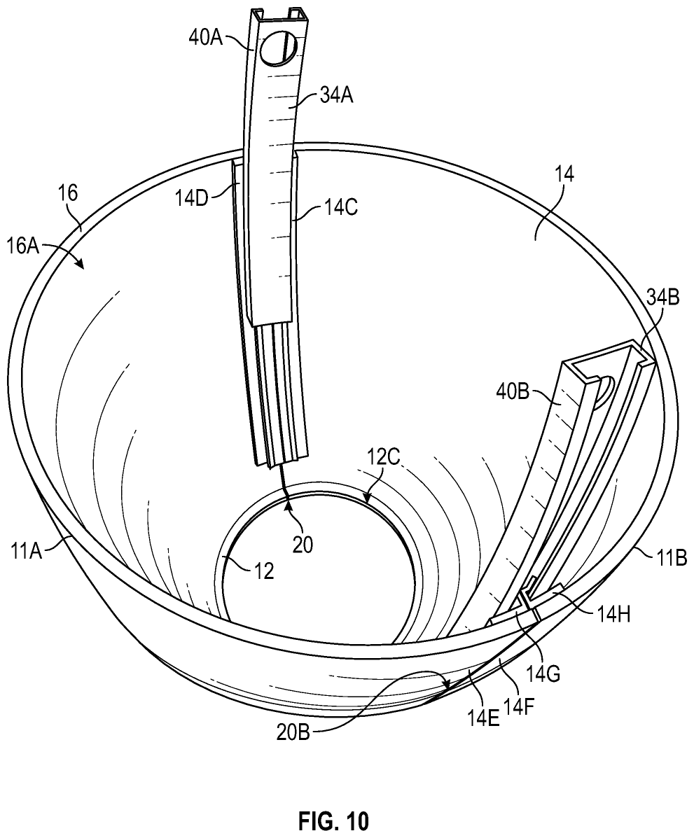

Turning now to the drawings, FIGS. 1-11 illustrate embodiments of a container 10 which can be used to pot pre-planted objects and/or objects having oversized ends rendering such objects incapable of being potted in traditional landscape and gardening containers. The container 10 includes a container body 11 defining an interior volume in which plant life 100, particulate matter 110, and/or other desired objects may be placed and at least one fastener 30, 30A, 30B transitionable between a disengaged and engaged configuration to transition the container 10 from an open configuration to a closed configuration and vice versa. In some embodiments, the container body 11 may be defined by a base 12 and a sidewall 14 extending upwardly from the periphery of the base 12. In an embodiment, the container body 11 may include an annular base 12, as shown best in FIGS. 4, 6-7, and 10. In some embodiments, the base 12 may be alternatively shaped, e.g., triangularly shaped, square shaped, or rectangularly shaped. In an embodiment, the base 12 and the sidewall 14 may be integrally formed such that base 12 and the sidewall 14 constitute a single, unitary component. Alternatively, the base 12 and sidewall 14 may be two separate, individual components secured together. In some embodiments, the container body 11 may be defined by the sidewall 14 alone, as shown in FIG. 9. In some embodiments, the sidewall 14 may be shaped or formed so that an upper portion of the sidewall 14 forms a rim 15. In some embodiments, the exterior of the container body 11, the interior of the container body 11, or both may have surface ornamentation.

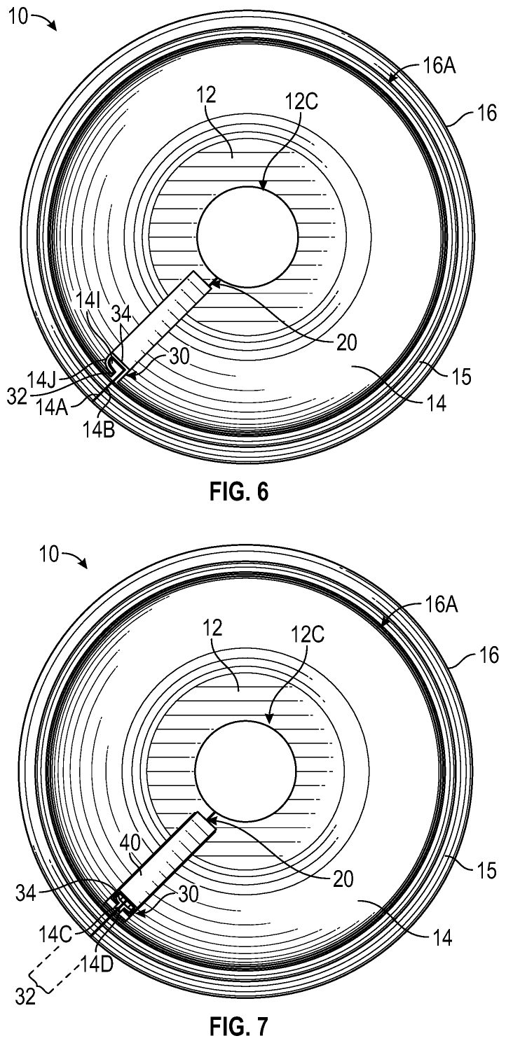

The container body 11 includes a top end 16 with an opening 16A therein and an opposing bottom end with an opening 12C therein to permit vertical insertion or deposit of objects having one or more ends with a diameter not exceeding that of the top opening 16A and/or bottom opening 12C into the container's 10 interior volume. The top opening 16A and the bottom opening 12C may be of equal or varying sizes. In one embodiment, the top opening 16A may have a diameter greater than the diameter of the bottom opening 12C. In some embodiments, the top end 16 and top opening 16A may be defined by the sidewall 14 while the bottom end and bottom opening 12C may be defined by a base 12 from which the sidewall 14 extends, as shown, e.g., in FIGS. 6-7. In some embodiments, the diameter of the container body 11 may increase as the container body 11 extends from the bottom end to the top end. In one embodiment, the sidewall 14 defines both the top end 16 and top opening 16A as well as the bottom end and bottom opening 12C, as shown, e.g., in FIG. 9. In addition to permitting the vertical insertion of smaller objects into the interior volume, the top opening 16A and bottom opening 12C of the container body 11 may serve to permit elongated objects, such as the trunk of a tree 110A, as shown in FIG. 1, to longitudinally extend through the entirety of the container body 11. The bottom opening 12C may also act as a port permitting drainage from the container's 10 interior volume into the an external environment. In an embodiment, the container body 11 may include a base 12 having a plurality of openings therein for drainage.

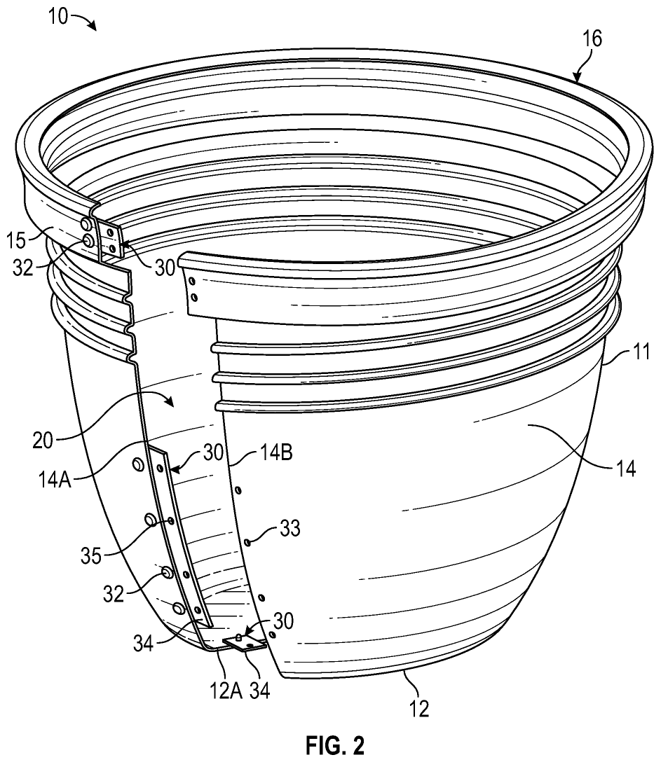

Unlike traditional gardening and landscaping containers currently known within the art, the body 11 of the container 10 of the present disclosure is configured to transition from an open configuration to a closed configuration, and vice versa, thereby permitting plant life 100, particulate matter 110, and/or other desired objects to be horizontally inserted or deposited into the container's 10 interior volume. To this end, the container body 11 includes one or more breaks 20, 20A, 20B extending from the top end 16 of the container body 11 to the bottom end of the container body 11 such that the one or more breaks 20, 20A, 20B extends from the top opening 16A to the bottom opening 12C. In this way, the container body 11 is of non-continuous construction, i.e., a gap is present within the base 12 and/or sidewall 14 which define the container body 11, depending on the embodiment. Such non-continuous construction of the container body 11 enables the container body 11 to be horizontally manipulated to adjust the width exhibited by the one or more breaks 20, 20A, 20B when the container 10 is an open configuration. The direction and angle in which the one or more breaks 20, 20A, 20B extends from the top end 16 to the bottom end of the container body 11 may vary. In some embodiments, the one or more breaks 20, 20A, 20B may extend from the top opening 16A to the bottom opening 12C in a generally straight, linear direction, as shown, e.g., in FIG. 4. In other embodiments, the one or more breaks 20, 20A have one or more curved portions, as shown, e.g., in FIG. 2, or otherwise extend from the top opening 16A to the bottom opening 12C in non-linear fashion.

In some embodiments, the container body 11 may include a single break 20, as shown in

FIGS. 1-8. In such embodiments, the width exhibited by the break 20 corresponds to the distance between a first edge and a second edge of the container body 11, as shown by comparing FIGS. 1 and 2. Depending on the construction of the container body 11, the first edge of the container body 11 may be defined by a first edge of a base 12A and a first edge of the sidewall 14A or by a first edge of the sidewall 14A alone, and the second edge of the container body 11 may be defined by a second edge of the sidewall 14B and a second edge of the base 12B or by a second edge of the sidewall 14B alone. As such, the width exhibited by the break 20 may be increased by increasing the distance between the container body's 11 first and second edge, and, conversely, may be decreased by decreasing the distance between the container body's 11 first and second edge. In an embodiment, where the container body 11 includes a single break 20, a single fastener 30 may be used to facilitate transition of the container 10 from a closed configuration to an open configuration, or vice versa, though the single fastener 30 may comprise a plurality of separate components, as shown best in FIGS. 2 and 6-7.

To place the container 10 in an open configuration, the fastener 30 of the container 10 is placed in a disengaged configuration and the container body 11 is manipulated such that the container body's 11 first edge and second edge are spaced apart causing the break 20 to exhibit a first width, as shown, e.g., in FIG. 2. Accordingly, when the container 10 is in an open configuration the width of the break 20 may be adjusted to facilitate horizontal insertion or deposit of plant life 100, particulate matter 110, or other desired objects into the container's 10 interior volume. For instance, the width of the break 20 may be adjusted to a first width of sufficient diameter allow passage of a tree trunk 100A through the break 20. To place the container 10 in a closed configuration, the container body 11 is manipulated such that its first and second edges are directly adjacent, thereby causing the break 20 to exhibit a second width smaller than the first width, as shown, e.g., in FIG. 1, and the container's 10 fastener 30 is placed in an engaged configuration. When the container 10 is placed in a closed configuration the second width exhibited by the break 20 is generally fixed and may be sufficiently small so that plant life 100, particulate matter 110, or other objects inserted into the container's 10 interior volume cannot exit through the break 20.

In another embodiment, the container body 11 may include a plurality of breaks 20A, 20B, as shown in FIGS. 9-11. In some embodiments, the container body 11 may have a first break 20A and a second break 20B, where the width of the first break 20A corresponds to a distance between the container body's 11 first and second edges and the width of the second break 20B corresponds to the distance between a third and fourth edge of the container body. Depending on the construction of the construction of the container body 11, the third edge of the container body 11 may be defined by a third edge of the base 12D and a third edge of the sidewall 14E or a third edge of the sidewall 14E alone, and the fourth edge of the container body 11 may be defined by a fourth edge of the base 12E and a fourth edge of the sidewall 114F or by the fourth edge of the sidewall 14F alone. As such, the width exhibited by the second break 20B may be increased by increasing the distance between the container body's 11 third an d fourth edge, and conversely, may be decreased by decreasing the distance between the container body's 11 third and fourth edge. In an embodiment, where the container body 11 includes a first break 20A and a second break 20B, a first fastener 30A corresponding to the first break 20A and second fastener 30B corresponding to the second break 20B may be used to facilitate transition of the container 10 from a closed configuration to an open configuration, or vice versa, as shown in FIGS. 9-11.

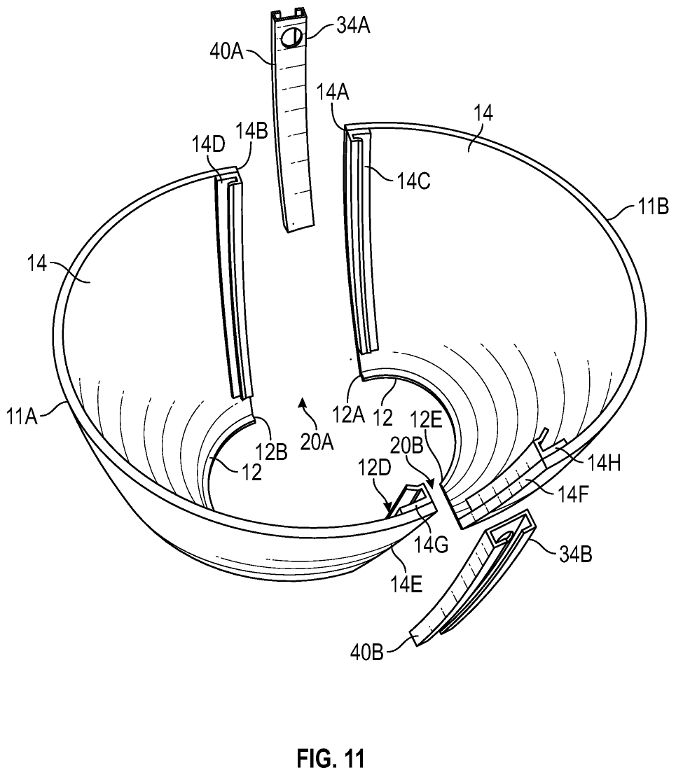

In embodiments where the container body 11 includes a first break 20A and a second break 20B, the container 10 may be placed in an open configuration by placing the first fastener 30A in a disengaged configuration and separating the container body's 11 first and second edges in the manner described above, placing the second fastener 30B in a disengaged configuration and spacing the container body's 11 third and fourth edges apart from one another causing the second break 20B to exhibit a third width, or by disengaging both the first and second fasteners 30A, 30B and separating the container body's first edge from its second edge and its third edge from its fourth edge causing the first break 20A to exhibit a first width and the second break 20B to exhibit a third width, as shown in FIG. 11. Accordingly, when the container 10 is in an open configuration either the width of the first break 20A, the width of the second break 20B, or both may be adjusted to facilitate horizontal insertion or deposit of plant life 100, particulate matter 110, or other desired objects into the container's 10 interior volume. For instance, the width of either the first break 20A or the second break 20B may be adjusted to a first width or third width, respectively, of sufficient diameter allow passage of a tree trunk 110A through the first or second break 20A, 20B. As shown in FIG. 9, to place the container in 10 in a closed configuration, the container body 11 is manipulated so that the container body's 11 first and second edges are directly adjacent, thereby causing the first break 20A to exhibit a second width smaller than the first width, and the container body's 11 third and fourth edges are directly adjacent, thereby causing the second break 20B to exhibit a fourth width smaller than the third width, and the first and second fasteners 30A, 30B are placed in an engaged configuration. When the container 20 is placed in a closed configuration, the second width exhibited by the first break 20A and the fourth width exhibited by the second break 20B may be sufficiently small so that plant life 100, particulate matter 110, or other objects inserted into the container's 10 interior volume cannot exit through either the first or second break 20A, 20B.

As shown best in FIGS. 9-11, in embodiments where the container body 11 includes a first break 20A and a second break 20B, the container body 11 may be defined by a first body member 11A and a second body member 11B. In some embodiments, the first body member 11A and the second body member 11B may be of equal size and dimension, as shown best in FIG. 11. In other embodiments, the first body member 11A and the second body member 11B may be of unequal size and dimension. In an embodiment, the first body member 11A and the second body member 11B may be removably secured together when at least one of the first fastener 30A and the second fastener 30B are in an engaged configuration. Conversely, when both the first and second fasteners 30A, 30B are placed in a disengaged configuration, the container body 11 may be separable into the first body member 11A and the second body member 11B. In some embodiments, the first break 20A and the second break 20B may be disposed opposite each other when the container 10 is in a closed configuration, as shown, e.g., in FIG. 9.

To permit the container 10 to transition from an open configuration to a closed configuration, or vice versa, the container body 11 may be constructed of a flexible or semi-rigid material. In some embodiments, the container body 11 may be constructed, at least in part, of a plastic material. In an embodiment, where the container body 11 includes only a single break 20, the rigidity of the material used to construct the container body 11 may be such that the container body 11 is resiliently biased towards a position where the container body's 11 first and second edges are directly adjacent. In one embodiment, where the container body 11 includes a first break 20A and a second break 20B, the container body 11 may be constructed of rigid material.

The container's 10 one or more fasteners 30, 30A, 30B serve to hold the container 10 in a closed configuration or to release the container 10 into an open configuration. Each fastener 30, 30A, 30B is transitionable between an engaged configuration and a disengaged configuration. When each of the container's 10 one or more fasteners 30, 30A, 30B are placed in an engaged configuration, the container body's 11 third and fourth edge and/or container body's 11 first and second edges are held directly adjacent to one another in the manner described above, thereby causing the container 10 to retain a closed configuration. Conversely, when at least one of the container's 10 one or more fasteners 30, 30A, 30B are placed in a disengaged configuration, the container 10 retains an open configuration where the width of one or more breaks 20, 20A, 20B within the container body may be adjusted to facilitate the horizontal insertion or deposit of objects into the container's 10 interior volume. The container's 10 one or more fasteners 30, 30A, 30B may be any instrument or device suitable for transitioning between an engaged configuration to hold the container 10 in a closed configuration and a disengaged configuration to release the container 10 into an open configuration in the manner disclosed herein. Accordingly, the design and structural features of the one or more fasteners 30, 30A, 30B may vary.

In some embodiments, the one or more fasteners 30, 30A, 30B may be defined by a first interlocking member 32, 32A, 32B and a second interlocking member 34, 34A, 34B compatible and configured to interlock with the first interlocking member 32, 32A, 32B. In such embodiments, the one or more fasteners 30, 30A, 30B retain an engaged configuration when the first interlocking member 32, 32A, 32B is interlocked with the second interlocking member 34, 34A, 34B and a disengaged configuration when the first interlocking member 32, 32A, 32B and the second interlocking member 34, 34A, 34B are not interlocked.

In an embodiment, the one or more fasteners 30, 30A, 30B may each include a first interlocking member 32, 32A, 32B defined by one or more screws, nails, bolts, or a combination thereof and a second interlocking member 34, 34A, 34B defined by one or more brackets configured to receive the one or more components defining the first interlocking member 32, 32A, 32B. In an embodiment, each of the one or more brackets defining the one or more second interlocking members 34, 34A, 34B includes a first side securable proximate to one edge of the container body 11 and a second side securable proximate to another edge of the container body 11 such that each bracket extends across a break 20, 20A, 20B when the container 10 is placed in a closed configuration, as shown best in FIG. 3.

In some embodiments, where the container body 11 includes a single break 20, the container 30 may include a single fastener 30 having a second interlocking member 34 defined by one or more brackets, where each bracket has a first side secured proximate to the container body's 11 first edge and a second side securable proximate the container body's 11 second edge, as further shown in FIGS. 2-3. In other embodiments, where the container body 11 includes a first break 20A and a second break 20B, the container 10 may include a first fastener 30A and a second fastener 30B each having a second interlocking member 34A, 34B defined by one or more brackets. In such embodiments, the one or more brackets defining the second interlocking member 34A of the first fastener 30A may each have a first side secured proximate to the container body's 11 first edge and a second side securable proximate the container body's 11 second edge while the one or more brackets defining the second interlocking member 34B of the second fastener 30B may each have a first side secured proximate to the container body's third edge and a second side securable proximate the container body's fourth edge. When either the first side, the second side, or both the first and second sides of the one or more brackets defining a second interlocking member 34, 34A, 34B is unsecured from the container body 11, the fastener 30, 30A, 30B to which the one or more unsecured brackets corresponds is in a disengaged configuration and the container 10 is in an open configuration, as shown best in FIG. 2. Conversely, when both the first and second side of the one or more brackets defining a second interlocking member 34, 34A, 34B are secured to the container body 11, the fastener 30, 30A, 30B to which the one or more secured brackets corresponds is in an engaged configuration, as shown best in FIG. 3.

In some embodiments, the container's 10 one or more first interlocking members 32, 32A, 32B and one or more second interlocking members 34, 34A, 34B may be removably secured together by placing the one or more second interlocking members 32, 32A, 32B on an interior or exterior surface of the container body and passing the one or more first interlocking members 32, 32A, 32B through the container body 11 and into the one or more second interlocking members 34, 34A, 34B, as shown best in FIGS. 1-3. To facilitate passage of the one or more first interlocking members 32, 32A, 32B through the container body 11, the container body 11 may, in some embodiments, have one or more openings 33 therein disposed proximate to the container's 10 one or more breaks 20, 20A, 20B, as shown in FIG. 1. In some embodiments, the container's 10 one or more first interlocking members 32, 32A, 32B may have a first set of threading and the container's 10 one or more second interlocking members 34, 34A, 34B may have a second set of threading compatible with the first set of threading.

In another embodiment, the one or more fasteners 30, 30A, 30B of the container 10 may include a first interlocking member 32, 32A, 32B and a second interlocking member 34, 34A, 34B each defined by a portion of the container body, as shown in FIG. 6. In an embodiment, the container 10 may include a fastener 30, 30A having a first interlocking member 32, 32A defined by a first portion 14I of the container body 11 and a second interlocking member 34, 34A defined by a second portion 14J of the container body 11. The first portion 14I of the container body 11 defining the first interlocking member 32, 32A and the second portion 14J of the container body 11 defining the second interlocking member 34, 34A may each be defined by either a portion of the base 12 and sidewall 14 or by a portion of the sidewall 14 alone. For instance, in some embodiments, the first portion 14I may be defined, at least in part, by a first edge of the sidewall 14A and the second portion 14J may be defined, at least in part, by a second edge of the sidewall 14B, as shown in FIG. 6. In some embodiments, the container 10 may further include a second fastener 30B having a first and second interlocking member 32B, 34B defined by a third and fourth portion (not shown) of the container body 11. In one such embodiment, the third and fourth portion of the container body 11 may be defined, at least in part, by a third edge of the sidewall 14E and a fourth edge of the sidewall 14F, respectively.

In some embodiments, each portion of the container body 11 defining either a first interlocking member 32, 32A, 32B, or a second interlocking member 34, 34A, 34B of a fastener 30, 30A, 30B may retain a generally hook-like shape, as best shown in FIG. 6. Thus, in some embodiments, one or more fasteners 30, 30A, 30B of the container 10 may be clasp-type fasteners. In some embodiments, the first and second portion of the sidewall 14I, 14J may be sized and shaped such that the first portion of the sidewall 14I is at least partially encapsulated by the second portion of the sidewall 14J when the two are interlocked, as further shown in FIG. 6. In an embodiment, a third and fourth portion of the sidewall may be defined, at least in part, by a third edge of the sidewall 14E and a fourth of edge of the sidewall 14F, respectively, and may be sized and shaped such that the third portion of the sidewall is at least partially encapsulated by the fourth portion of the sidewall when the two are interlocked. In such embodiments, fastener 30, 30A may be placed in an engaged configuration by clasping the first portion of the sidewall 14I and the second portion of the sidewall 14J together and the second fastener 30B may be placed in an engaged configuration by clasping the third and fourth portions of the sidewall together. Conversely, fastener 30, 30A may be placed in a disengaged configuration by unclasping the first and second portions of the sidewall 14I, 14J and the second fastener 30B may be placed in a disengaged configuration by unclasping the third and fourth portions of the sidewall.

In another embodiment, the container's 10 one or more fasteners 30, 30A, 30B may include a first interlocking member 32, 32A, 32B defined by a first slide engagement member 14C, 14G and a second slide engagement member 14D, 14H and a second interlocking member 34, 34A, 34B defined by a sliding member 40, 40A, 40B configured to slidably engage and interlock with the first and second slide engagement members 14C, 14D, 14G, 14H. Thus, in some embodiments, the container 10 may include one or more slide-type fasteners.

In an embodiment, the first slide engagement member 14C, 14G and second slide engagement member 14D, 14H defining each fastener's 30, 30A, 30B first interlocking member 32, 32A, 32B may be secured to a surface of the container body, as shown in FIGS. 7 and 9-11. In one embodiment, container 10 may include fastener 30, 30A having its first slide engagement member 14C secured proximate to a first edge of the container body 11 and its second slide engagement member 14D secured proximate to a second edge of the container body 11 so that when the fastener's 30, 30A sliding member 40, 40A slidably engages the first and second slide engagement members 14C, 14D, the fastener 30, 30A is placed in an engaged configuration. In some embodiments, the container 10 may further include a second fastener 30B having its first slide engagement member 14G secured proximate to a third edge of the container body 11 and its second slide engagement member 14H secured proximate to a fourth edge of the container body 11 so that when the second fastener's 30B sliding member 30B slidably engages the first and second slide engagement members 14G, 14H, the second fastener 30B is placed in an engaged configuration. The first slide engagement member 14C, 14G and second slide engagement member 14D, 14H of each fastener 30, 30A, 30B may be secured to an interior or exterior surface of the container body 11 in some embodiments. In an embodiment, the first slide engagement members 14C, 14G and second slide engagement members 14D, 14H of each fastener 30, 30A, 30B may be secured to a surface of the container body 11 using an adhesive, though other suitable instruments or devices may be used to secure such members.

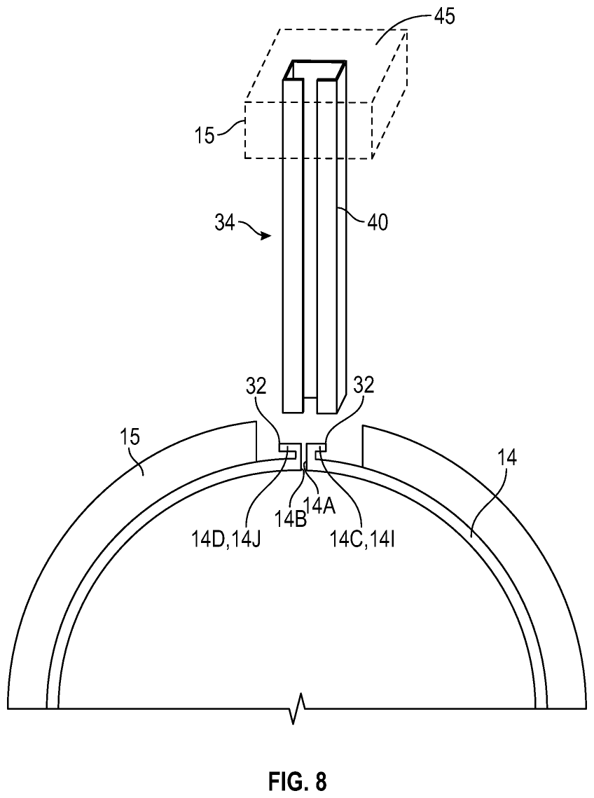

In some embodiments, the first slide engagement member 14C, 14G and the second slide engagement member 14G, 14H of one or more of the container's 10 fasteners 30, 30A, 30B may be integrally formed within the container body 11. For instance, in one embodiment, the container body 10 may include a fastener wherein its first slide engagement member 14C is defined by a first portion 14I of the container body 11 and its second slide engagement member 14D is defined by a second portion 14J of the container body 11, as shown in FIG. 8. As shown in FIG. 8, in some embodiments, the first slide engagement member 14C, 14G, the second slide engagement member 14D, 14H, and the sliding member 40, 40A, 40B of the one or more fasteners 30, 30A, 30B may be disposed outside of the container body's 11 interior when the container 10 is in a closed configuration. In other embodiments, the second slide engagement member 14D, 14H, and the sliding member 40, 40A, 40B of the one or more fasteners 30, 30A, 30B may be disposed inside of the container body's 11 interior when the container 10 is in a closed configuration, as shown in FIGS. 7 and 9-11. In some embodiments, the sliding member 40, 40A, 40B of the one or more fasteners 30, 30A, 30B may have an ornamental portion 45 secured thereto. In one embodiment, the container 10 a sliding member 40 with an ornamental portion 45 secured thereto that defines a portion of the container body's 11 rim 15 when the container 10 is in a closed configuration.

In another embodiment, the container's 10 one or more fasteners 30, 30A, 30B may include a first interlocking member 32, 32A, 32B defined by the male member of a snap-fit fastener (not shown) and a second interlocking member 32, 32A, 32B defined by the female member of the snap-fit fastener (not shown). In such embodiments, the male member of the snap-fit fastener may have one or more resiliently biased arms which are displaced and subsequently interlock with the female member of the snap-fit fastener when the two are combined. When the male member of the snap-fit fastener defining the first interlocking member 32, 32A, 32B is interlocked with the female member of the snap-fit fastener defining the second interlocking member 34, 34A, 34B, the fastener 30, 30A, 30B is in an engaged configuration. Conversely, when the male member of the snap-fit fastener defining the first interlocking member 32, 32A, 32B and the female member of the snap-fit fastener defining the second interlocking member 34, 34A, 34B are not interlocked, the fastener 30, 30A, 30B is a disengaged configuration.

In another embodiment, the container's 10 one or more fasteners 30, 30A, 30B may each include a first interlocking member 32, 32A, 32B defined by a male member of a snap button (not shown) and the second interlocking member 34, 34A, 34B may be defined by the female member of the snap button (not shown). In such embodiments, when the male member of the snap button defining the first interlocking member 32, 32A, 32B is interlocked with the female member of the snap button defining the second interlocking member 34, 34A, 34B, the fastener is in an engaged configuration. Conversely, when the male member of the snap button defining the first interlocking member 32, 32A, 32B and the female member of the snap button defining the second interlocking member 34, 34A, 34B are not interlocked, the fastener 30, 30A, 30B is in a disengaged configuration.

Because the container 10 of the present disclosure is adapted to receive objects within its interior volume by way of both horizontal and vertical insertion or deposit and subsequently store the same, the container 10 of the present disclosure may be utilized to pot plant life 100 whose roots 100B have already been sown into a ground surface 200, as shown in FIG. 1. Thus, in another aspect, the present disclosure is directed to a method for potting pre-planted objects, such as a tree. To pot a pre-planted object using the container 10 of the present disclosure, the container 10 is placed in an open configuration, which may include placing at least one fastener of the container's 10 one or more fasteners 30, 30A, 30B in a disengaged configuration. Once the container 10 is in an open configuration, the width of a break 20, 20A, 20B within the container body 11 is adjusted to a width greater than that of the pre-planted object to be potted or a portion thereof. The pre-planted object is then passed through the break 20, 20A, 20B into the container's 10 interior volume. In some instances, where the length of the pre-planted object is greater than the height of the container 10, the pre-planted object may extend through the top opening 16A and bottom opening 12C of the container body 11. Once the pre-planted object is disposed within the container's 10 interior volume, the container's 10 one or more fasteners 30, 30A, 30B are each placed in an engaged configuration causing the container 10 to retain a closed configuration. After the pre-planted object is potted within the container 10, particulate matter 110, such as potting soil or mulch, may be vertically inserted or deposited into the container's 10 interior volume via the top opening 16A and/or bottom opening 12C of the container body 11. The container 10 may be similarly used and the foregoing steps may be similarly carried out to pot non pre-planted objects having opposing ends exhibiting diameters greater than the container's 10 top and bottom openings 16A, 12C and a midsection exhibiting a second diameter smaller than the container's 10 top and bottom openings 16A, 12C.

It is understood that versions of the inventive subject matter of the present disclosure may come in different forms and embodiments. Additionally, it is understood that one of skill in the art would appreciate these various forms and embodiments as falling within the scope of the inventive subject matter disclosed herein.

What is claimed is:

1) A container for potting pre-planted objects, the container comprising:
a container body having a top end with a first opening, a bottom end with a second opening, and a break having a width, the break extending from the first opening to the second opening; and
a fastener transitionable between an engaged configuration and a disengaged configuration, the width being adjustable when the fastener is in a disengaged configuration.

2) The container of claim 1, wherein the fastener comprises a first interlocking member and a second interlocking member.

3) The container of claim 2, wherein at least one of the first interlocking member and the second interlocking member is defined by one or more portions of the container body.

4) The container of claim 1, wherein the fastener includes a sliding member.

5) The container of claim 4, wherein the sliding member includes an ornamental portion defining a portion of the container body.

6) The container of claim 1, wherein the diameter of the container body increases as the container body extends from the bottom end to the top end.

7) The container of claim 1, wherein the container body comprises a base defining the bottom end and a peripheral sidewall extending upwardly from the base and defining the top end.

8) The container of claim 1, wherein the container body includes a second break and a second fastener transitionable between an engaged configuration and disengaged configuration.

9) The container of claim 8, wherein the container body is defined by a first body member and a second body member, the first body member and the second body member being removably secured together when at least one of the fastener and the second fastener is in an engaged configuration.

10) The container of claim 9, wherein the first body member and the second body member are of equal size.

11) The container of claim 8, wherein the break is disposed opposite the second break when the fastener and the second fastener are in an engaged configuration.

12) The container of claim 1, wherein the first opening has a first diameter and the second opening has a second diameter smaller than the first diameter.

13) A container for potting pre-planted objects, the container comprising:
a container body defining an interior volume, the container body having a top end with a first opening, a bottom end with a second opening, and a break having a width, the break extending from the first opening to the second opening; and
a fastener comprising a first interlocking member and second interlocking member, the fastener being transitionable between an engaged configuration and a disengaged configuration, wherein the width is adjustable when the fastener is in a disengaged configuration, and wherein at least one of the first interlocking member and the second interlocking member is disposed within the interior volume when the fastener is in an engaged configuration.

14) The container body of claim 13, wherein the container body includes a second break extending from the first opening to the second opening and a second fastener comprising a third interlocking member and a fourth interlocking member, the second fastener being transitionable between an engaged configuration and a disengaged configuration and the container body being separable into a first body member and a second body member when the fastener and the second fastener are each in a disengaged configuration.

15) The container of claim 14, wherein at least one of the third interlocking member and the fourth interlocking member is disposed within the interior volume when the second fastener is in an engaged configuration.

16) The container of claim 14, wherein the second interlocking member and the fourth interlocking member are each defined by a sliding member.

17) The container of claim 16, wherein at least one of the first interlocking member and the third interlocking member is secured to an interior surface of the container body.

18) The container body of claim 16, wherein at least one of the first interlocking member and the third interlocking member is defined by one or more portions of the container body.

19) The container of claim 16, wherein the first interlocking member is defined by a first slide engagement member disposed on the first body member proximate to the break and a second slide engagement member disposed on the second body member proximate to the break and the third interlocking member is defined by a third slide engagement member disposed on the first body member proximate to the second break and a fourth slide engagement portion disposed on the second body member proximate to the second break.

20) A container for potting pre-planted objects, the container comprising:
a container body defining ang interior volume, the container body having a bottom end with a first opening defined by an annular base, a top end with a second opening defined by a peripheral sidewall extending upwardly from the base, a first break having a first width and extending from the first opening to the second opening, a second break having a second width and extending from the first opening to the second opening;
a first slide-type fastener comprising a first interlocking member and a second interlocking member compatible with the first interlocking member; and
a second slide-type fastener comprising a third interlocking member and a fourth interlocking member compatible with the third interlocking member, wherein the first fastener and the second fastener are each transitionable between an engaged configuration and a disengaged configuration, the container body is separable into a first body member and a second body member when the first fastener and the second fastener are each in a disengaged configuration, and the first fastener and the second fastener are each disposed within the interior volume of the container body when first fastener and the second fastener are in an engaged configuration.
